(19) United States
(12) Patent Application Publication
(10) Pub. No.: US 2025/0292063 A1
(43) Pub. Date: Sep. 18, 2025

(54) AI-ASSISTED CONTENT ADMINISTRATION SYSTEM FOR GROUP ADMINS

(71) Applicant: Microsoft Technology Licensing, LLC, Redmond, WA (US)

(72) Inventors: Amisha Chirag AGRAWAL, Surat (IN); Sandeep Singh ADHIKARI, Karnataka (IN); Yashu SETH, Patna (IN); Dharmendra Kumar GOYAL, Bengaluru (IN); Nitesh LULLA, Thubrahalli (IN); Somya GUPTA, Bengaluru (IN)

(21) Appl. No.: 18/606,808

(22) Filed: Mar. 15, 2024

(51) Int. Cl. G06N 3/045; G06F 40/35

(52) U.S. Cl. CPC G06N 3/045; G06F 40/35

(57) ABSTRACT

A system and method for AI assisted content administration system is described. In one aspect, a computer-implemented method includes accessing group content submissions to an online community platform, computing, using a suggestion retrieval system, a group-to-post relevance score for each post from the group content submissions, identifying, using a first machine learning model of the suggestion retrieval system, a set of recommended posts from the group content submissions having the group-to-post relevance score that at least reaches a group-to-post relevance score threshold for a group, classifying at least one post from the set of recommended posts as relevant or non-relevant to the group using a second machine learning model of the intent-based ranking system, computing a relevance ranking score of at least one post from the set of recommended posts classified as relevant to the group, and identifying a set of suggested posts.

### TECHNICAL FIELD

The present disclosure generally relates to technical problems encountered in machine learning. More specifically, the present disclosure relates to processing user-generated content using two distinct machine-learning models.

### BACKGROUND

The subject matter disclosed herein generally relates to a special-purpose machine that organizes and surfaces relevant content, including computerized variants of such special-purpose machines and improvements to such variants. Specifically, the present disclosure addresses systems and methods for content administration of a content management application.

Managing online communities that allow user-generated content submissions presents a complex problem for the computing system. Such a computing system aims to balance member engagement by providing new and relevant content while ensuring that the community remains free of spam, self-promotion, and off-topic posts. Without active moderation, community contributions tend to decline over time, which can ultimately lead to a loss of members. However, manual moderation of each user-generated post is arduous and time-consuming for administrators, which only worsens as the community grows in popularity.

### BRIEF DESCRIPTION OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating an AI-assisted content administration system in accordance with one example embodiment.

FIG. 3 is a block diagram illustrating an intent-based content ranking system in accordance with one example embodiment.

FIG. 4 illustrates an example process of calculating a relevance score of a post in accordance with one example embodiment.

FIG. 5 illustrates an example process of an AI-assisted content administration system in accordance with one example embodiment.

FIG. 6 illustrates an example process of an intent-based content ranking system in accordance with one example embodiment.

FIG. 7 illustrates a routine 700 in accordance with one embodiment.

FIG. 8 illustrates a routine 800 in accordance with one embodiment.

FIG. 9 is block diagram showing a software architecture within which the present disclosure may be implemented, according to an example embodiment,

FIG. 10 is a diagrammatic representation of a machine in the form of a computer system within which a set of instructions may be executed for causing the machine to perform any one or more of the methodologies discussed herein, according to an example embodiment.

### DETAILED DESCRIPTION

### Overview

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Online community systems that allow users to submit their content face the challenge of balancing user engagement and content moderation. On the one hand, without active moderation, user-generated contributions tend to decrease over time. On the other hand, user-generated posts often contain spam, self-promotion, or off-topic content that requires frequent intervention by admin users to validate the posts. As the number of user-generated posts requiring review increases, the system frequently pauses publication until admin users can review them.

One possible solution to the challenge mentioned above is to train a machine-learning (ML) model that can predict the probability of a post containing spam, self-promotion, or off-topic content. However, there are several technical issues with this approach. Firstly, the reliability of such a model would be poor because a single model would not have access to a wider range of data characteristics beyond the text content in the postings. Secondly, a single model would not be accurate enough to determine whether other published posts outside the group are relevant to the group because the model is trained to detect spam only with respect to a specific group.

The present application describes a computer system that processes user-generated content using two distinct ML models. A first ML model is trained to identify and flag potential spam, self-promotion, or off-topic content. The computer system automates approving or rejecting flagged content to reduce pending publication pauses. In addition to moderation, the second ML model analyzes and identifies other topics and content submitted outside a group. This information can guide content creation and curation efforts, ensuring that the community members remain engaged and active. User feedback can be used to adjust the threshold parameters of the machine learning models.

In one example embodiment, the present application describes a system having two Components: a suggested post-retrieval system and an intent-based relevance system. The suggested post-retrieval system identifies public posts that are relevant to a group.

First, the suggested post-retrieval system identifies the meaning and context of the text in the public post based on group topic clusters using embeddings from published group posts, group titles and descriptions, and public posts. As such, the suggested post-retrieval system can identify public posts that are relevant to a group by mapping groups to topic clusters.

Second, the suggested post-retrieval system determines the likelihood of a public post being relevant based on the similarities of group member profile attributes with user attributes from user profiles.

The suggested post-retrieval system also includes a group-to-post relevance score generator that computes a relevance score based on the following:
(a) the group-to-topic cluster mapping (from the semantic analysis) and the post-to-topic cluster mapping (from the statistical analysis)
(b) the relevance of the post to the prevalent user profile attribute of the group (from the statistical analysis)

The intent-based relevance system categorizes a pending post as relevant or non-relevant, and a public post (from the suggested post-retrieval system) as relevant or irrelevant. The intent-based relevance system generates an overall relevance score based on a combination of a supervised model relevance score from a supervised learning model and an unsupervised model relevance score from an unsupervised learning model. The supervised learning model operates a trained Siamese network to assess the similarity between the text of group posts/suggested public posts and a group's attributes (e.g., title and description). The unsupervised learning model applies a clustering technique to measure a cosine similarity of posts' embeddings with embeddings of centroids of all clusters. In one example embodiment, the intent-based relevance system computes the average of the similarity score from the supervised learning model with the similarity score from the unsupervised learning model to generate the overall relevance score.

The intent-based relevance system identifies a threshold for the similarity score. If the average similarity score for any given group/suggested public post exceeds the threshold, the post is categorized as relevant to the group.

As such, the presently disclosed computer system describes a machine learning-based classification system that provides a more efficient process to identify relevant public postings to a group. Such a classification system results in the computer system operating more efficiently without frequent pauses to query user validation of the public posts/pending posts' relevance to a group.

To address the challenge described above, the present application relates, in one example embodiment, computer systems that assist administrators in moderating content. These systems use various techniques, such as machine learning, natural language processing, and relevance scores, to identify and flag potential spam, self-promotion, or off-topic content. The systems can also automate the process of approving or rejecting flagged content, reducing the workload of administrators. In addition to moderation, these systems can help community administrators in other ways. For example, they can analyze and identify other topics and content submitted outside a group. This information can guide content creation and curation efforts, ensuring that the community members remain engaged and active. The systems can also analyze user feedback to identify areas of improvement for the platform, helping the administrators to make data-driven decisions. Overall, computer systems play a crucial role in managing user-generated content in online communities, and they help to ensure that the community remains a safe, engaging, and valuable space for all its members.

In one example embodiment, the present application describes a system that includes machine learning models to assist community administrator workflows and effectively optimize for automated relevance classification and personalized content recommendation. The relevance classification system employed by the platform is designed to help administrators focus their moderation efforts on high-quality content that is most relevant to the community.

The system performs a combination of semantic and statistical analysis. Through semantic analysis, the meaning and context of the text in each post are understood, enabling the system to identify posts relevant to the community. Statistical analysis is also used to determine the interests of the community, leveraging the most common relevant factor among the community members.

Analyzing user-generated content in this way ensures that moderators spend their time effectively, only reviewing content that meets the highest standards. The relevance classification system makes it easier for users to find high-quality content within the community while ensuring that administrators can maintain an engaging and safe environment. Automating this process provides users with a seamless experience, ensuring that moderators can work efficiently and effectively.

The system also utilizes AI-powered algorithms to provide personalized content recommendations to each community based on their interests and attributes. Public posts across the platform are automatically matched and suggested to each community. This creates a personalized feed of supplemental content for admins to import into their communities easily. This personalized content recommendation process helps community admins keep their members engaged and interested in the community.

The AI-powered algorithms assist the community admins in content moderation and sourcing. By automating these processes, the admins can reduce their workload and spend more time on other important tasks. The AI models are trained on a continuous feedback-based mechanism, which helps to improve the accuracy of content moderation and sourcing over time.

The solution described in the present application can be applied to diverse online community platforms with user-generated content. The system provides an efficient and effective way to personalize content recommendations, automate content moderation and sourcing, and improve member engagement.

In one example embodiment, a computer-implemented method for an AI-assisted content administration system is described. In one aspect, the computer-implemented method includes accessing group content submissions to an online community platform, computing, using a suggestion retrieval system, a group-to-post relevance score for each post from the group content submissions, identifying, using a first machine learning model of the suggestion retrieval system, a set of recommended posts from the group content submissions having the group-to-post relevance score that at least reaches a group-to-post relevance score threshold for a group, where the group is associated with a group attribute, classifying, using an intent-based ranking system and the group attribute, at least one post from the set of recommended posts as relevant or non-relevant to the group using a second machine learning model of the intent-based ranking system, computing, using the intent-based ranking system, a relevance ranking score of the at least one post from the set of recommended posts classified as relevant to the group using the second machine learning model, and identifying, using the intent-based ranking system, a set of suggested posts having the relevance ranking score that at least reaches a relevance ranking score threshold of the group. The computer-implemented method also includes causing at least one post of the set of suggested posts to be presented on a device.

As a result, one or more of the methodologies described herein facilitate solving the technical problem of batch processing of user-generated content and identifying user-generated content pertinent to a group of an online community platform. As such, one or more of the methodologies described herein may prevent a need for certain efforts or computing resources. Such computing resources include processor cycles, network traffic, memory usage, data storage capacity, power consumption, network bandwidth, and cooling capacity.

### DESCRIPTION

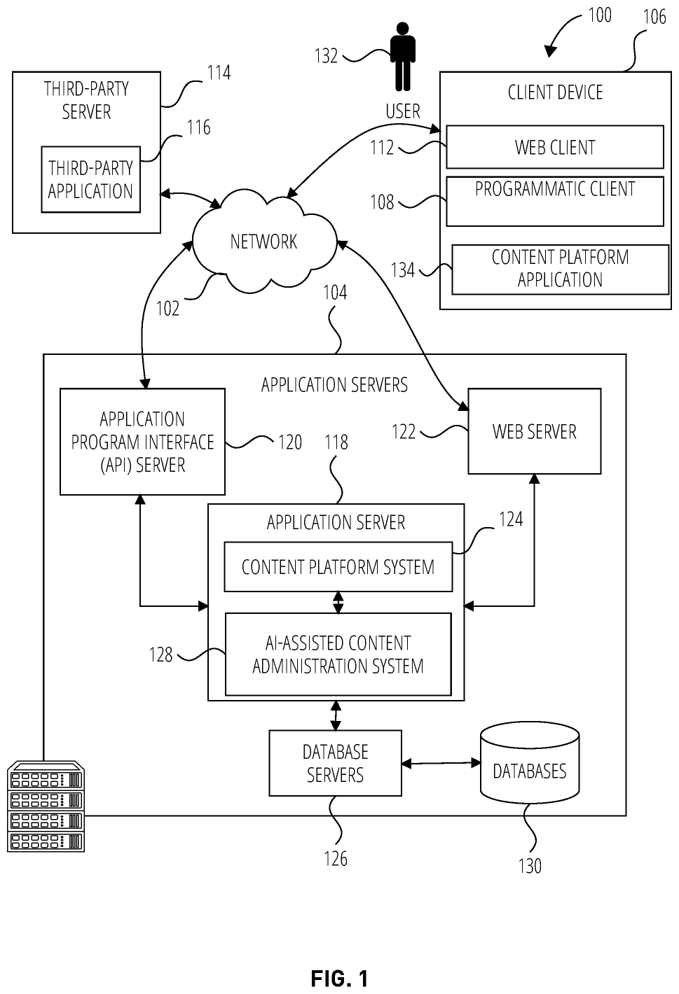

FIG. 1 is a diagrammatic representation of a network environment where some example embodiments of the present disclosure may be implemented or deployed. One or more application servers 104 provide server-side functionality via a network 102 to a networked user device in the form of a client device 106. A user 132 operates the client device 106. The client device 106 includes a web client 112 (e.g., a browser) and a programmatic client 108 (e.g., an email/calendar application such as Microsoft Outlook™) that is hosted and executed on the client device 106. In one example embodiment, the programmatic client 108 includes a content platform application 110 that surfaces items relevant to the user 132. For example, the content platform application 110 retrieves relevant items and presents the relevant items by using the graphical user interface of the programmatic client 108 to visualize the applicable items in the context of the programmatic client 108 (e.g., email/contact application). The content platform application 110 may operate with the web client 112 and/or the programmatic client 108. In another example embodiment, the content platform application 110 is part of the programmatic client 108 or web client 112. For example, the content platform application 110 may operate as an extension or add on to the web client 112.

An Application Program Interface (API) server 120 and a web server 122 provide respective programmatic and web interfaces to application servers 104. A specific application server 118 hosts a content platform system 124 and an AI-assisted content administration system 128. Both content platform system 124 and AI-assisted content administration system 128 include components, modules and/or applications.

The content platform system 124 may include a social networking server (a distributed system comprising one or more machines) that provides server-side functionality via the network 102. The content platform system 124 includes, among other modules, an interest model (not shown), a match-score calculator (not shown), and a group recommender (not shown). The interest model is the model that calculates scores for interests associated with a text segment, and the match-score calculator calculates the match score between a post and a group. The group recommender determines if a group recommendation will be presented to the user posting new content.

In one example embodiment, the content platform system 124 is a network-based appliance, or a distributed system with multiple machines, which responds to initialization requests or search queries from client device 106. The content platform system 124 tracks the activities of the users in the online service, and the databases 130 keeps information about the posts generated by users, including the posts added to groups. The content platform system 124 can also track profile information about the users, information about the groups in the online service, and calculated interests for the different groups in the online service. Since the interests of the groups tend to remain constant, the group interests are calculated periodically.

In some example embodiments, when a user initially registers to become a user of the social networking service provided by the content platform system 124, the user is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the user profile database (e.g., in databases 130). Similarly, when a representative of an organization initially registers the organization with the social networking service provided by the content platform system 124, the representative may be prompted to provide certain information about the organization, such as a company industry.

The content platform system 124 may also include a search engine (not shown). The content platform system 124 may retrieve search results (and, potentially, other data) from multiple search engines (e.g., third-party search engines).

In another example, client device 106 may access the content platform system 124 to post and view user-generated content shared with other peer users. Other examples of content platform system 124 include enterprise systems, content management systems, and knowledge management systems.

In one example embodiment, the AI-assisted content administration system 128 enables management of content within the content platform system 124. The AI-assisted content administration system 128 uses artificial intelligence to identify and categorize content that is pertinent to a specific group within the content platform system 124.

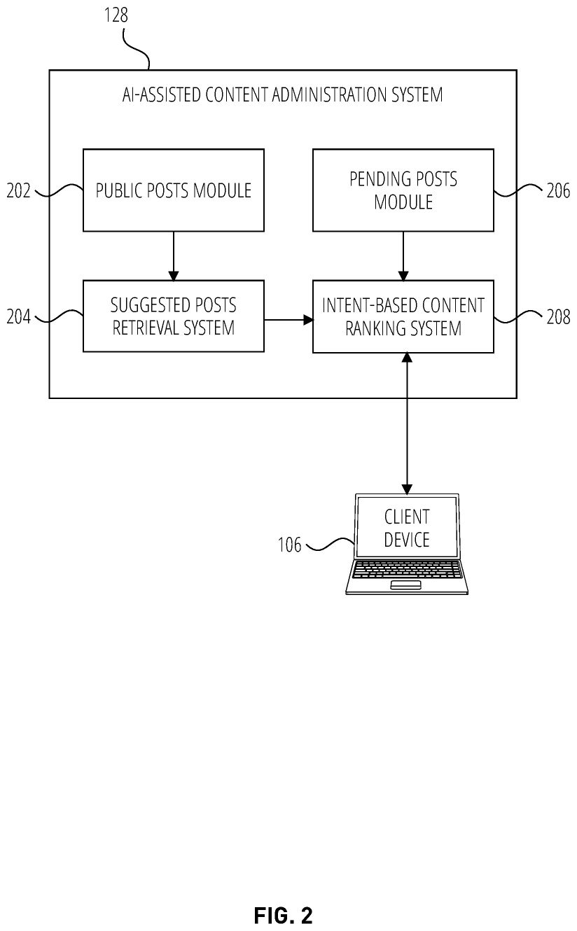

The AI-assisted content administration system 128 works with the content platform application 110. The AI-assisted content administration system 128 identifies and classifies user-generated content relevant to the group, making it easier to manage and organize the content. The AI-assisted content administration system 128 identifies and categorizes content and helps analyze user behavior, preferences, and patterns to provide personalized content recommendations for users. This ensures that users have the most relevant content that aligns with their interests and needs. An example of the AI-assisted content administration system 128 is described in more detail below with respect to FIG. 2.

The third-party application 116 may, for example, be another cloud storage system. The application server 118 is shown to be communicatively coupled to database servers 126 that facilitates access to an information storage repository or databases 130. In an example embodiment, the databases 130 includes storage devices that store information to be published and/or processed by the content platform system 124.

Additionally, a third-party application 116, executing on a third-party server 114, is shown as having programmatic access to the application server 118 via the programmatic interface provided by the Application Program Interface (API) server 120. For example, the third-party application 116, using information retrieved from the application server 118, may support one or more features or functions on a third-party website.

FIG. 2 is a block diagram illustrating an AI-assisted content administration system 128 in accordance with one example embodiment. The AI-assisted content administration system 128 is designed to interface with the client device 106. It includes several components that work to streamline the content moderation and administration process for online community platforms. The AI-assisted content administration system 128 serves as a hub for content analysis and decision-making. It is equipped with machine learning capabilities to evaluate content submissions and provide recommendations to community administrators.

In one example embodiment, the AI-assisted content administration system 128 includes a public posts module 202, a suggested posts retrieval system 204, a pending posts module 206, and an intent-based content ranking system 208.

The public posts module 202 identifies and retrieves all publicly shared content on the community platform. The public posts module 202 accesses different types of publicly available posts. For example, the public posts module 202 accesses user-generated content that has been posted using the content platform system 124. This includes all types of posts, such as text, images, videos, and other multimedia content that the users have shared publicly. In another example, the public posts module 202 retrieves public posts associated with specific interests and topics relevant to particular community groups.

The suggested posts retrieval system 204 is an automated system designed to analyze a vast collection of public posts available on an online community platform. The system identifies posts relevant to specific community groups by analyzing and categorizing them based on keywords, hashtags, and other parameters. This ensures that the system can identify the most valuable content relevant to the community members' specific interests.

Once the suggested posts retrieval system 204 identifies the relevant public posts, it delivers them to the intent-based content ranking system 208. This system further evaluates the posts based on predefined criteria. The system assigns a relevance score to each post based on its content, the engagement it has received, and the interests of the community members. This helps to prioritize the most valuable and pertinent content for community administrators to review.

The intent-based content ranking system 208 ensures that the most valuable content is preserved in the vast sea of public posts. It helps the administrators to focus on the most important posts that need to be reviewed, and this helps to ensure that the community members get the most out of the platform.

The pending posts module 206 manages the queue of user-generated content awaiting moderation. This module categorizes the pending posts into relevant and irrelevant content. This reduces the manual effort required by administrators to maintain content standards and community relevance. By doing so, the system ensures that the community members are not exposed to any content that is not appropriate or relevant to their interests.

The client device 106 serves as the end-user interface for the community administrator, providing a seamless and interactive experience for managing content. By accessing the outputs of the AI-assisted content administration system 128 through the client device 106, administrators can effortlessly manage the flow of content, including the well-organized feeds of pending and suggested posts.

The client device 106 empowers administrators to view various content suggestions, including text, images, and videos. By reviewing these suggestions, administrators can decide whether to approve or reject them, ensuring that only appropriate content is displayed on the community platform. The client device 106 also provides a user-friendly interface for administrators to provide feedback on the content suggestions, enabling the AI-assisted system to refine its content analysis algorithms and improve future recommendations.

Through the client device 106, administrators can perform moderation actions such as flagging inappropriate content, approving or rejecting posts, or providing feedback to the AI-assisted content administration system. This moderation mechanism ensures that the community platform remains a safe and welcoming place for all users, with relevant, engaging, and appropriate content.

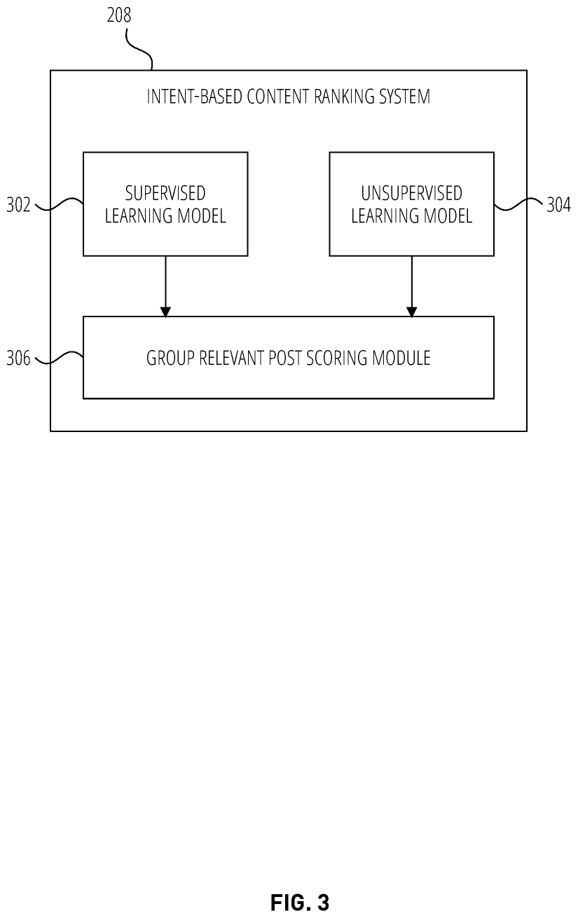

FIG. 3 is a block diagram illustrating the intent-based content ranking system 208 in accordance with one example embodiment. This system is designed to classify and rank user-generated content based on its relevance to a specific group within an online community platform. In other words, the intent-based content ranking system 208 classifies posts into relevant and non-relevant posts. Also, it provides a score to rank relevant posts by their relevance to the group. To achieve this, the intent-based content ranking system 208 combines supervised learning techniques (e.g., supervised learning model 302) and unsupervised learning techniques (e.g., unsupervised learning model 304). These models work in concert to analyze content and determine its appropriateness and value to the group's objectives and interests.

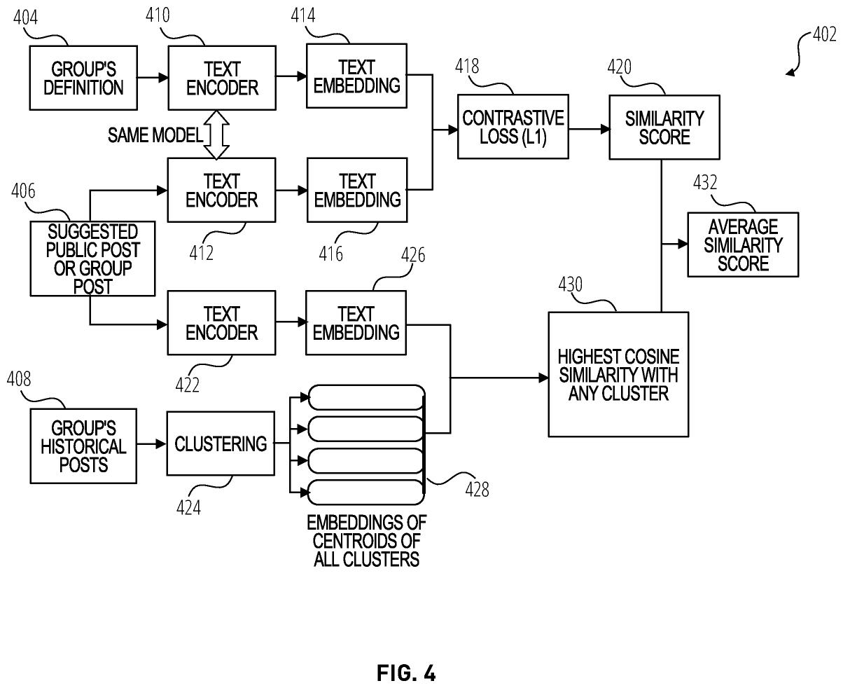

The supervised learning model 302 utilizes historical data, such as previous actions taken by group admins (e.g., approvals or rejections of posts), to learn and predict the relevance of new content submissions. The supervised learning model 302 compares the content of a new submission (e.g., user-generated content post) against the group's defined interests, which may include the group's title, description, and any other relevant metadata. The supervised learning model 302 outputs a similarity score that reflects the likelihood of the content being applicable to the group. One example of supervised learning model 302 is described further below with respect to FIG. 4.

In one example embodiment, the supervised learning model 302 includes a supervised Siamese network that assesses the similarity between the text of group posts/suggested public posts and the group's definitions (title and description). The ground truth for determining group post relevance is derived from actions taken by group admins (e.g., posting approvals or deletions). In another example embodiment, suggested public posts generated by suggested posts retrieval system 204 can be used to train this model.

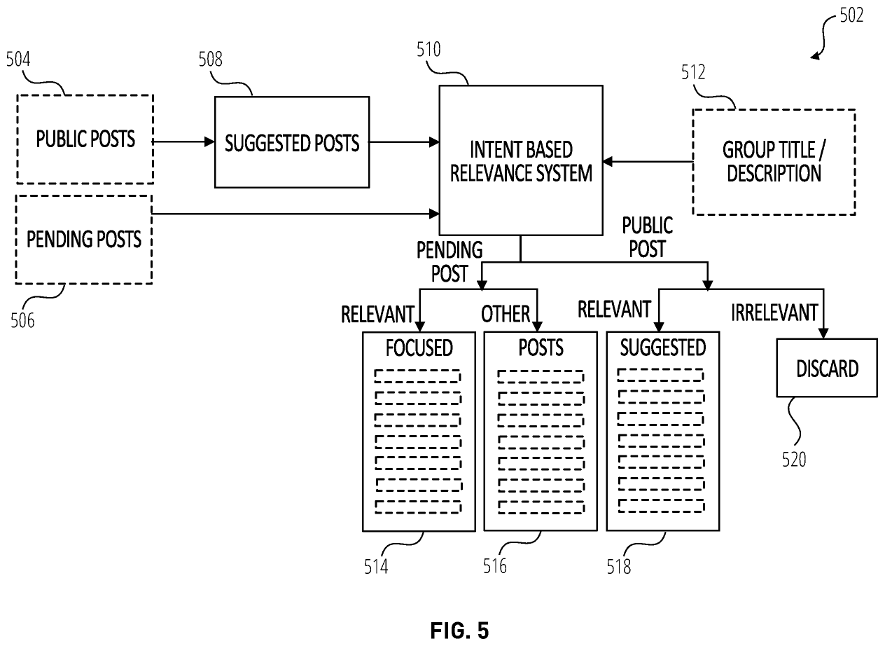

In the initial stages, the ground truth for suggested posts is labeled by annotators. Once the suggested posts retrieval system 204 is deployed in production, the suggested posts are displayed in a “Suggested” tab (e.g., suggested posts 518) as shown in FIG. 5. The admin has the option of accepting/rejecting those suggestions. The admin action serves as the ground truth label (e.g., relevant/irrelevant) for the supervised learning model 302. The admin actions establish a feedback loop that guides the process of model re-training. The feedback loop ensures that the supervised learning model 302 continuously learns and adapts based on real-world admin actions, enhancing its accuracy.

To train supervised learning model 302, pairs of positive and negative examples are curated. Positive pairs include group posts/suggested public posts that admins and the corresponding group definitions have approved. Negative pairs include rejected group posts/suggested public posts and corresponding model definitions. The supervised learning model 302 can be trained using contrastive loss. During inference time, for any new group post/suggested public post, the trained Siamese network calculates the relevance score for each post.

The unsupervised learning model 304 does not rely on labeled data. Instead, the unsupervised learning model 304 examines the intrinsic structure of the content by clustering historical group posts into different categories based on their similarities. When a new post is submitted, the unsupervised learning model 304 assesses which cluster it aligns with most closely and assigns a similarity score based on that alignment.

In one example, the historical group posts are organized into distinct clusters by applying appropriate clustering (e.g., K-Means, DBSCAN, or Hierarchical Clustering) algorithms. When a new group post is submitted, the cosine similarity of the post's embeddings is measured with the embeddings of the centroids of all the clusters. Then, the cluster with which the new post shares the highest cosine similarity is selected. The highest cosine similarity is considered to be the similarity score of the post.

The group relevant post-scoring module 306 receives the similarity scores from both the Supervised Learning Model (302) and the Unsupervised Learning Model (304). The group relevant post scoring module 306 integrates the scores to produce a final relevance score for each post. The combined score is a more robust indicator of relevance as it encapsulates the explicit feedback from group admins and the implicit patterns discovered through unsupervised learning.

In one example, the group-relevant post-scoring module 306 merges the similarity scores obtained from the supervised Siamese network and the unsupervised content clustering by taking their simple average.

The final relevance score generated by the group relevant post scoring module 306 ranks the posts, with higher-scoring posts deemed more relevant to the group's interests. These ranked posts are then presented to the group admins for review, enabling them to decide which content to approve, reject, or further investigate.

In another example embodiment, using a dedicated test dataset, the intent-based content ranking system 208 identifies an ideal threshold for the similarity score. If the average similarity score for any given group/suggested public post surpasses this predefined threshold, the post is categorized as relevant to the group.

By aggregating similarity scores from these models and setting an appropriate threshold, the precision and recall of post-categorization are enhanced. These relevant posts are subsequently placed in a separate queue for admin review.

FIG. 4 illustrates an example process of calculating a relevance score of a post in accordance with one example embodiment. This process is part of the AI-assisted content administration system 128 and relates explicitly to intent-based content ranking system 208. FIG. 4 is a flowchart that outlines the steps involved in determining the relevance of a suggested public post or group post to the group's definition, which includes the group's title and description. The process combines supervised and unsupervised learning models to generate a comprehensive relevance score. The text encoder 410 processes the group definition 404 to generate text embedding 414. The text encoder 412 processes the suggested public post 406 to generate text embedding 416. The text encoder 422 processes the suggested public post 406 to generate text embedding 426. In one example, the text encoder 410 begins with converting the group definition 404 into a numerical representation (e.g., text embedding 414). The text encoder 410 translates the textual information into a format that machine learning models can process.

The contrastive loss 418 includes a contrastive loss function used to calculate the similarity score between the group's definition and the post. The function evaluates the distance between the embeddings of the group's definition and the post, with a smaller distance indicating a higher similarity.

The similarity score 420 refers to similarity scores obtained from the supervised learning model. The similarity score 420 and the highest cosine similarity 430 are averaged to produce a single score (e.g., average similarity score 432) that reflects the post's relevance to the group's definition.

The unsupervised learning model 304 utilizes historical posts from the group (e.g., group historical posts 408) to understand the context and topics typically associated with the group. For each cluster, a centroid (e.g., embeddings of centroids of all clusters 428) is calculated, which is the central point that represents the average of all posts within the cluster.

The new post is compared to each cluster's centroid to find the highest cosine similarity (e.g., highest cosine similarity 430), which indicates the cluster with which the post is most closely associated. The text embedding 426 of the new post is used in this comparison to determine its similarity to existing clusters. The text encoder 422 generates the numerical representation required for the cosine similarity calculation.

The group historical posts 408 are organized into clustering 424 based on their content. Each cluster (embeddings of centroids of all clusters 428) represents a set of posts with similar themes or topics.

The final output of this process is a relevance score that indicates how well the post aligns with the group's interests and historical content. This relevance score ranks the post among other content being considered for sharing with the group. The higher the relevance score, the more likely the post is to be pertinent to the group and, thus, the more likely it is to be presented to the group admin for approval.

FIG. 5 illustrates an example process of an AI-assisted content administration system 128 in accordance with one example embodiment. The process depicted in FIG. 5 is designed to enhance the efficiency of content moderation within an online community by utilizing AI to classify and suggest content for group admins.

The diagram is divided into several key components, each representing a step in the content administration process:

Public Posts 504: This component represents the pool of all public posts available on the online community platform. Users generate these posts and are publicly accessible, not limited to any specific group.

Suggested posts 508: This component selects a subset of posts from the larger pool of public posts (public posts 504). It uses a level-1 selection process to identify posts that may be relevant to specific groups within the community.

Intent-based relevance system 510: Following the initial selection of the suggested posts, the posts are further evaluated by the intent-based relevance system 510. This component ranks the posts based on their relevance to the group's interests, which is determined by analyzing the content of the posts and comparing them to the group's defined topics and objectives.

Group title and description 512: This input provides the intent-based relevance system 510 with the necessary context to assess the relevance of posts. It includes the title and description of the group, which encapsulates the group's theme and purpose.

Pending Posts (e.g., relevant posts 514 and other posts 516): These are posts created by group members awaiting moderation. They still need to be visible to the entire group and require approval by a group admin.

Relevant posts 514: The AI-assisted content administration system 128 classifies pending posts into a “Focused” category if they are deemed highly relevant to the group's interests. These posts are prioritized for the admin's review. The admin can approve all posts within the ‘Focused’ category, streamlining the moderation process.

Other posts 516: Posts classified as less relevant or off-topic are placed in the ‘Other’ category. These require further review by the admin and may be less likely to be approved for the group. The admin can reject all posts within the ‘Other’ category in a single action.

Suggested posts 518: This category includes posts the system identified as potentially valuable for the group based on the intent-based relevance system 510. These suggestions are generated from the broader pool of public posts and are offered to the admin for consideration.

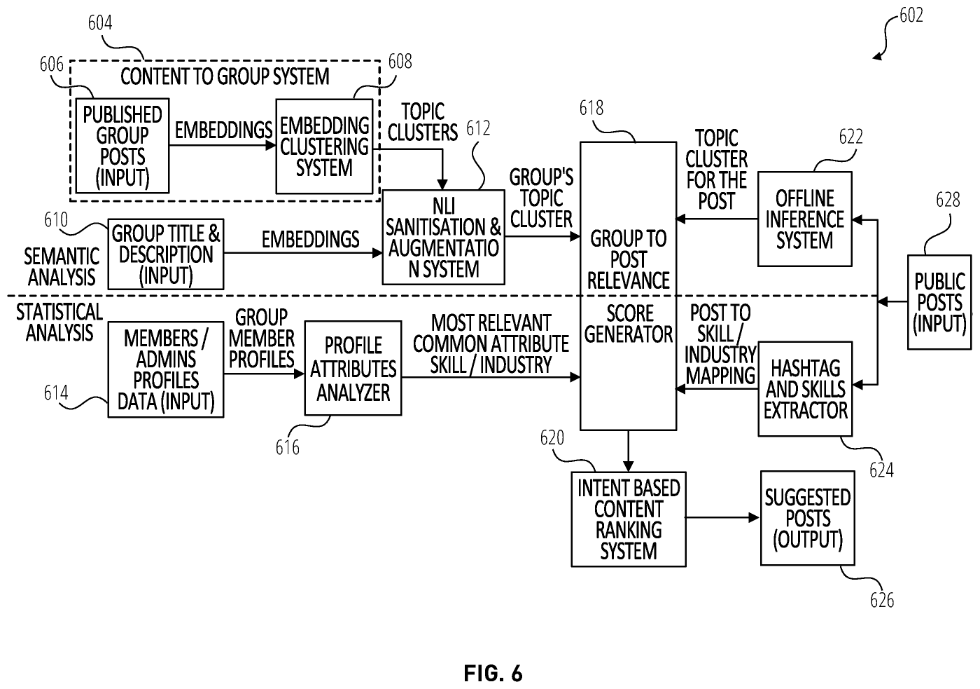

FIG. 6 illustrates an example process of an intent-based content ranking system in accordance with one example embodiment. FIG. 6 specifically focuses on evaluating public posts for relevance to a particular group within an online community platform. This figure details the workflow and components involved in the statistical analysis and semantic analysis of public posts and group attributes to generate a relevance score for each post.

The diagram is organized into several interconnected modules, each representing a step in the process:

Published group posts 606: This module represents the collection of posts published within a group. These posts serve as input data for generating topic clusters that reflect the common themes or subjects discussed within the group.

Embedding clustering system 608: The clustering system organizes the group posts into topic clusters based on their content.

Group title and description 610: The title and description of a group provide contextual information that is used to understand the group's focus and to guide the content analysis process. A semantic analysis is performed on the group's title and description and on the textual representation of interest clusters. In one example, the group title and description 610 are processed to generate embeddings that are vector representations of the group posts and the group's title and description. These embeddings are used in subsequent analysis steps. A Natural Language Inference (NLI) model can be used to determine the probability of entailment between the group's description and the interest clusters.

Sanitization and augmentation system 612: A Natural Language Inference (NLI) model is used to sanitize and augment the topic clusters for the group based on the group's title and description. In one example, the sanitization and augmentation system 612 refines and enhances the mapping of groups to topic clusters. The sanitization and augmentation system 612 ensures that the content suggested to a group is highly relevant and adheres to the group's defined interests. Sanitization involves cleaning the existing mappings by removing or reducing noise, which includes irrelevant or weak associations between groups and topic clusters. Conversely, augmentation involves enriching the mappings by adding new, relevant associations that were not previously captured. This dual process helps maintain the integrity and relevance of the content being considered for each group, thereby improving the user experience within the online community.

The sanitization and augmentation system 612 operates by utilizing a Natural Language Inference (NLI) model that takes the group's title and description as inputs and compares them with the textual representation of interest clusters. The NLI model outputs a probability score that reflects the likelihood of the group's description being in entailment with the interest clusters. For sanitization, the sanitization and augmentation system 612 uses this score to filter out mappings that do not meet a certain threshold of relevance, effectively reducing noise. For augmentation, the sanitization and augmentation system 612 leverages the same score to identify and add new mappings where the group's description strongly aligns with an interest cluster, enhancing the group's topic cluster mappings. Through this process, the sanitization and augmentation system 612 ensures that the content administration is accurate and efficient, facilitating better content moderation and curation for group admins.

Profile data 614: This input includes the profile data of members. For example, the profile data include attributes, such as the members' group, skills, or industry.

Profile attributes analyzer 616: This system analyzes the attributes of group members' profiles to identify the most relevant attributes for the group. In one example embodiment, in a parallel flow, profile attributes analyzer 616 runs a frequency analysis on profile data 614 (e.g., group member's profile skills and current industries) to find the most common relevant attribute (skill or industry) in the group members.

For each group and factor, a relevance score is generated as follows:

Skill Frequency=Number of group members having that skill÷number of members in the group

Inverse Universal Frequency=log(Members having the skill÷total member count)

Relevance Score=Skill Frequency*Inverse Universal Frequency

This is a novel measure of relevance based on TF-IDF (Term Frequency Inverse Document Frequency), which is only applied to text and document inputs.

The attribute (skill/industry) with the highest score is selected and passed down to the group to post-relevance score generator 618.

The final weighted score is generated based on the scores generated through the above two described mechanisms. Finally, posts are filtered based on the score to create a list of post recommendations for each group.

Posts recommended by the Suggestions Retrieval System undergo evaluation by the Intent-Based Content Ranking System, as detailed in the following section. This ranking system assigns a relevance score to each post, ensuring that only the most highly relevant posts are presented as suggestions.

Public posts 628: This represents the pool of public posts on the online community platform that are not specific to any group.

Offline interference system 622: This system processes the embeddings (from public posts 628) to infer the topic clusters for the group posts.

Hashtag and skills extractor 624: This Component extracts hashtags and skills from the data to assist in mapping posts to relevant topics or skills. Relevant hashtags are extracted, and based on those, the hashtag and skills extractor 624 fetches the relevant skills by leveraging hashtags to skills mapping data generated based on the statistical correlation between the skill and hashtag. These posts to skill/industry mapping are also fed to the group to post relevance score generator 618.

Group-to-post relevance score generator 618: This module generates a relevance score for each post about the group by combining the group-to-topic cluster mapping and the post-to-topic cluster mapping. The Group to Post Relevance Score Generator generates mapping of groups with public posts based on skills mappings, and a relevance score is generated for each mapping. In one example embodiment, the group-to-post relevance score generator 618 is fed with group-to-topic cluster mapping (generated with sanitization and augmentation system 612) and post-to-topic cluster mapping (generated with offline interference system 622). The group-to-post relevance score generator 618 uses both to create groups-to-post mappings with a relevance score calculated as follows:

Relevance Score of post to group=Relevance score of post to topic cluster*Concentration of group posts relevant to the topic cluster.

R(G1, P1)=R(P1, Ti)*Number of posts in group G1 relevant to Ti/Number of posts in the group. R represents a relevance score. G1 represents a group. P1 represents a posting. Ti represents the topic cluster that is most relevant to the given post.

Intent-based content ranking system 620: This system ranks the posts based on their relevance to the group, using the scores generated by the group to post relevance score generator 618.

Suggested posts 626: The final output of the system is a list of posts that are suggested for the group based on their relevance scores.

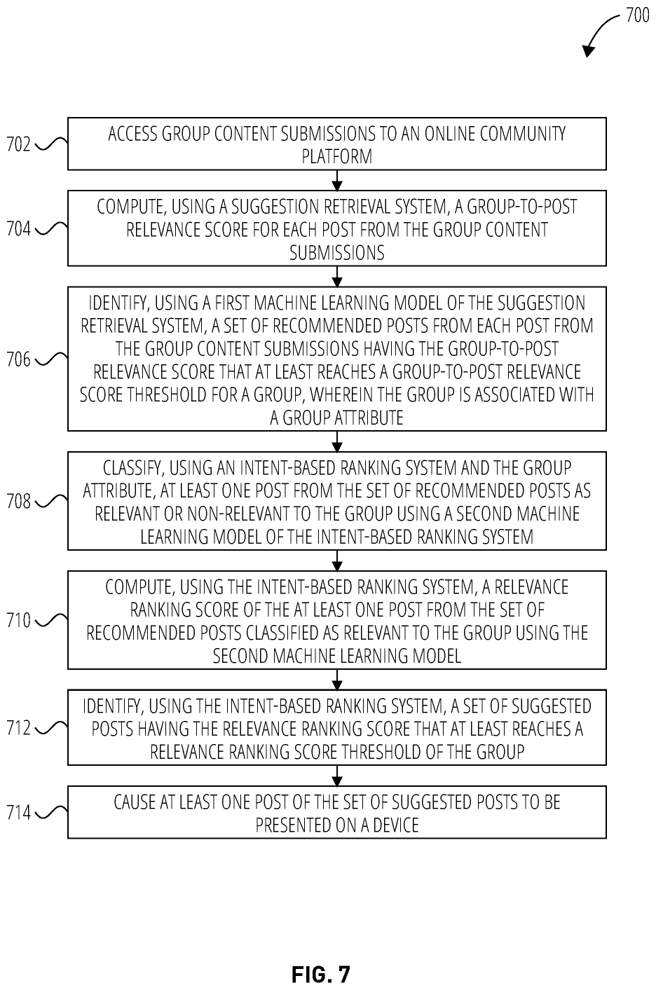

FIG. 7 illustrates a routine 700 in accordance with one embodiment. Operations in routine 700 may be performed by the AI-assisted content administration system 128, using Components (e.g., modules, engines) described above with respect to FIG. 3. Accordingly, routine 700 is described by way of example with reference to the AI-assisted content administration system 128. However, it shall be appreciated that at least some of the operations of routine 700 may be deployed on various other hardware configurations or be performed by similar components residing elsewhere. For example, some operations may be performed at the content platform application 110.

In block 702, routine 700 accesses group content submissions to an online community platform. In block 704, routine 700 computes, using a suggestion retrieval system, a group-to-post relevance score for each post from the group content submissions. In block 706, routine 700 identifies, using a first machine learning model of the suggestion retrieval system, a set of recommended posts from the group content submissions having the group-to-post relevance score that at least reaches a group-to-post relevance score threshold for a group, wherein the group is associated with a group attribute. In block 708, routine 700 classifies, using an intent-based ranking system and the group attribute, at least one post from the set of recommended posts as relevant or non-relevant to the group using a second machine learning model of the intent-based ranking system. In block 710, routine 700 computes, using the intent-based ranking system, a relevance ranking score of at least one post from the set of recommended posts classified as relevant to the group using the second machine learning model. In block 712, routine 700 identifies, using the intent-based ranking system, a set of suggested posts having a relevance ranking score that at least reaches a relevance ranking score threshold of the group. In block 714, routine 700 causes at least one post of the set of suggested posts to be presented on a device.

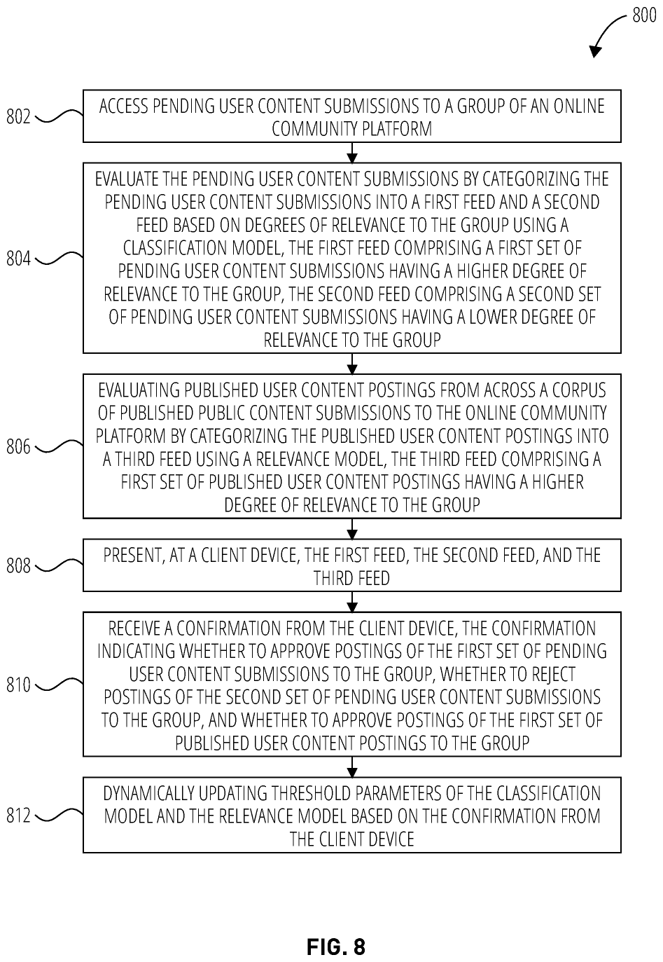

FIG. 8 illustrates a routine 800 in accordance with one embodiment. Operations in method 800 may be performed by the AI-assisted content administration system 128, using Components (e.g., modules, engines) described above with respect to FIG. 3. Accordingly, routine 800 is described by way of example with reference to the AI-assisted content administration system 128. However, it shall be appreciated that at least some of the operations of routine 800 may be deployed on various other hardware configurations or be performed by similar components residing elsewhere. For example, some of the operations may be performed at the content platform application 110.

In block 802, routine 800 accesses pending user content submissions to a group of an online community platform.

In block 804, routine 800 evaluates the pending user content submissions by categorizing the pending user content submissions into a first feed and a second feed based on degrees of relevance to the group using a classification model, the first feed comprising a first set of pending user content submissions having a higher degree of relevance to the group, the second feed comprising a second set of pending user content submissions having a lower degree of relevance to the group.

In block 806, routine 800 evaluates published user content postings from across a corpus of published public content submissions to the online community platform by categorizing the published user content postings into a third feed using a relevance model, the third feed comprising a first set of published user content postings having a higher degree of relevance to the group.

In block 808, routine 800 presents, at a client device, the first feed, the second feed, and the third feed.

In block 810, routine 800 receives a confirmation from the client device, the confirmation indicating whether to approve postings of the first set of pending user content submissions to the group, whether to reject postings of the second set of pending user content submissions to the group, or whether to approve postings of the first set of published user content postings to the group.

In block 812, routine 800 dynamically updates the threshold parameters of the classification model and the relevance model based on the confirmation from the client device.

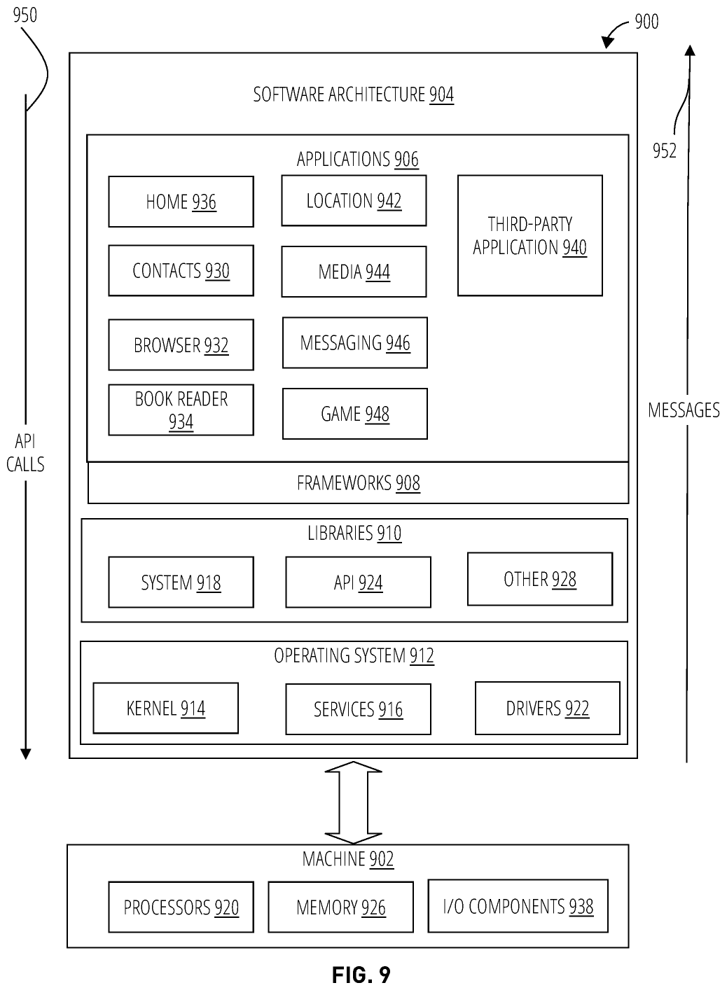

FIG. 9 is a block diagram 900 illustrating software architecture 904, which can be installed on any one or more of the devices described herein. The software architecture 904 is supported by hardware such as a machine 902 that includes Processors 920, memory 926, and I/O Components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, Processor management (e.g., scheduling), Component management, networking, and security settings, among other functionality. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 910 provide a low-level common infrastructure used by the applications 906. The libraries 910 can include system libraries 918 (e.g., C standard library) that provide functions such as memory allocation functions, string manipulation functions, mathematical functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

Frameworks 908 provides a high-level common infrastructure that is used by applications 906. For example, frameworks 908 provides various graphical user interface (GUI) functions, high-level resource management, and high-level location services. The framework 908 can provide a broad spectrum of other APIs that can be used by the applications 906, some of which may be specific to a particular operating system or platform.

In an example embodiment, the applications 906 may include a home application 936, a contacts application 930, a browser application 932, a book reader application 934, a location application 942, a media application 944, a messaging application 946, a game application 948, and a broad assortment of other applications such as a third-party application 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 950 provided by the operating system 912 to facilitate the functionality described herein.

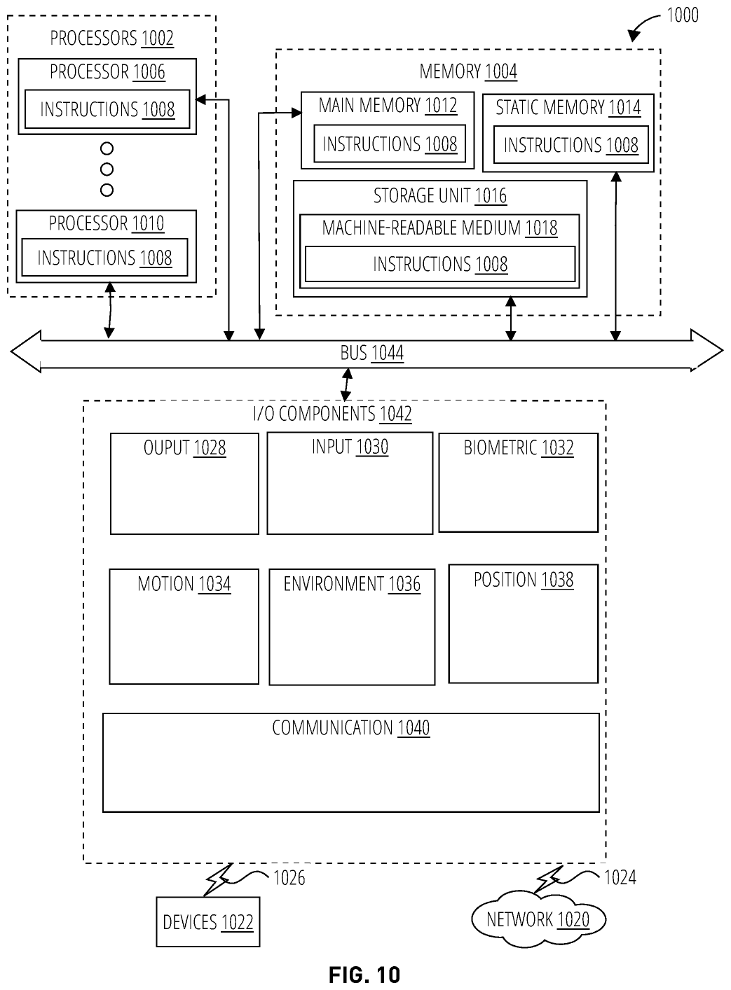

FIG. 10 is a diagrammatic representation of the machine 1000 within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute any one or more of the methods described herein. The instructions 1008 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines that individually or jointly execute the instructions 1008 to perform any one or more of the methodologies discussed herein.

The machine 1000 may include Processors 1002, memory 1004, and I/O Components 1042, which may be configured to communicate with each other via a bus 1044. In an example embodiment, the Processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a Processor 1006 and a Processor 1010 that execute the instructions 1008. The term “processor” is intended to include multi-core processors that may comprise two or more independent processors (sometimes referred to as “cores”) that may execute instructions contemporaneously. Although FIG. 10 shows multiple Processors 1002, the machine 1000 may include a single processor with a single core, a single processor with multiple cores (e.g., a multi-core processor), multiple processors with a single core, multiple processors with multiples cores, or any combination thereof.

The memory 1004 includes a main memory 1012, a static memory 1014, and a storage unit 1016, both accessible to the Processors 1002 via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the Processors 1002 (e.g., within the processor's cache memory), or any suitable combination thereof, during execution thereof by the machine 1000.

The I/O Components 1042 may include a wide variety of components to receive input, provide output, produce output, transmit information, exchange information, capture measurements, and so on. The specific I/O Components 1042 that are included in a particular machine will depend on the type of machine. For example, portable machines such as mobile phones may include a touch input device or other such input mechanisms, while a headless server machine will likely not include such a touch input device. It will be appreciated that the I/O Components 1042 may include many other components that are not shown in FIG. 10. In various example embodiments, the I/O Components 1042 may include output Components 1028 and input Components 1030. The output Components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input Components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O Components 1042 may include biometric Components 1032, motion Components 1034, environmental Components 1036, or position Components 1038, among a wide array of other Components. For example, the biometric Components 1032 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1034 include acceleration sensor components (e.g., accelerometer), gravitation sensor components, rotation sensor components (e.g., gyroscope), and so forth. The environmental Components 1036 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position Components 1038 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O Components 1042 further include communication Components 1040 operable to couple the machine 1000 to a network 1020 or devices 1022 via a coupling 1024 and a coupling 1026, respectively. For example, the communication Components 1040 may include a network interface component or another suitable device to interface with the network 1020. In further examples, the communication Components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication Components 1040 may detect identifiers or include Components operable to detect identifiers. For example, the communication Components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication Components 1040, such as location via Internet Protocol (IP) geolocation, location via Wi-Fi® signal triangulation, location via detecting an NFC beacon signal that may indicate a particular location, and so forth.

The various memories (e.g., memory 1004, main memory 1012, static memory 1014, and/or memory of the Processors 1002) and/or storage unit 1016 may store one or more sets of instructions and data structures (e.g., software) embodying or used by any one or more of the methodologies or functions described herein. These instructions (e.g., the instructions 1008), when executed by Processors 1002, cause various operations to implement the disclosed embodiments.

The instructions 1008 may be transmitted or received over the network 1020, using a transmission medium, via a network interface device (e.g., a network interface Component included in the communication Components 1040) and using any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy-enhancing tools for safeguarding user data. The techniques described herein may minimize the use of any personal data in training AI models, including removing and replacing personal data. According to the techniques described herein, notices may be communicated to users to inform them how their data is being used, and users are provided controls to opt out of their data being used for training AI models.

According to some embodiments, tools are used with the techniques described herein to identify and mitigate risks associated with AI in all products and AI systems. In some embodiments, notices may be provided to users when AI tools are being used to provide features.

### EXAMPLES

Example 1 is a computer-implemented method comprising: accessing group content submissions to an online community platform; computing, using a suggestion retrieval system, a group-to-post relevance score for each post from the group content submissions; identifying, using a first machine learning model of the suggestion retrieval system, a set of recommended posts from the group content submissions having the group-to-post relevance score that at least reaches a group-to-post relevance score threshold for a group, wherein the group is associated with a group attribute; classifying, using an intent-based ranking system and the group attribute, at least one post from the set of recommended posts as relevant or non-relevant to the group using a second machine learning model of the intent-based ranking system; computing, using the intent-based ranking system, a relevance ranking score of the at least one post from the set of recommended posts classified as relevant to the group using the second machine learning model; and identifying, using the intent-based ranking system, a set of suggested posts having the relevance ranking score that at least reaches a relevance ranking score threshold of the group; and causing at least one post of the set of suggested posts to be presented on a device.

In Example 2, the subject matter of Example 1 includes, training, using the suggestion retrieval system, the first machine learning model based on semantic attribute data from a first analysis of public posts and group description attributes, and statistical attribute data from a second analysis of group member profile attributes of the online community platform, wherein the group attribute comprises the group description attributes and group member profile attributes, wherein the group content submissions comprise: public posts and pending posts.

In Example 3, the subject matter of Example 2 includes, wherein the first analysis comprises: generating a mapping of groups-to-topic clusters using a group-to-topic clusters machine learning model; generating a mapping of post-to-topic clusters using a filtered posts topic cluster machine learning model, wherein the first machine learning model comprises the group-to-topic clusters machine learning model and the filtered posts topic cluster machine learning model.

In Example 4, the subject matter of Example 3 includes, generating a mapping of groups-to-posts based on the mapping of groups-to-topic clusters and the mapping of the post-to-topic clusters.

In Example 5, the subject matter of Example 4 includes, computing, using the mapping of groups to posts, the group-to-post relevance score for each post from the public posts and pending posts based on a product of a relevance score of a post-to-topic cluster and a concentration of group posts relevant to a topic cluster.

In Example 6, the subject matter of Examples 4-5 includes, wherein the second analysis comprises: identifying the group member profile attributes of the online community platform, wherein the group member profile attributes comprise a skill attribute, an industry attribute, a number of group members attribute, and a number of group members attribute having a predefined skill; computing a statistical analysis relevance score of a skill or an industry for the group based on the group member profile attributes; identifying a skill or an industry with the statistical analysis relevance score of the skill or industry for the group exceeding a skill or industry group to post relevance score threshold for the group; generating skill and industry group mapping based identifying the skill or the industry with the statistical analysis relevance score of the skill or industry for the group exceeding the skill or industry group to post relevance score threshold for the group, wherein the group-to-post relevance score is further based on the skill and industry group mapping.

In Example 7, the subject matter of Example 6 includes, wherein the second analysis comprises: identifying hashtags from the public posts; and identifying relevant hashtags from the hashtags based on hashtag to skills mapping data generated based on a statistical correlation between skills and hashtags.

In Example 8, the subject matter of Examples 3-7 includes, wherein generating the mapping of groups to topic clusters comprises: augmenting or sanitizing the mapping of groups-to-topic clusters by using a natural language inference model (NLI) with a group title and description, and textual representation of interest clusters as inputs, wherein the natural language inference model outputs a probability of two text samples being related to one another.

In Example 9, the subject matter of Examples 1-8 includes, wherein the second machine learning model of the intent-based ranking system comprises: a supervised learning model comprising a Siamese network that assesses a similarity between text of group posts and a group definition; an unsupervised learning model that applies a clustering algorithm to organize group posts into distinct clusters, wherein the intent-based ranking system is configured to combine a first similarity score from the supervised learning model and a second similarity score from the unsupervised learning model to identify a similarity score of published public group content submission or pending group content submission, the similarity score exceeding a predefined threshold indicating a submission as relevant to the group.

In Example 10, the subject matter of Examples 2-9 includes, generating a first feed comprising one or more posts from the pending posts with a corresponding relevance score exceeding the relevance ranking score threshold of the group; generating a second feed comprising one or more posts from the pending posts with a corresponding relevance score lower than the relevance ranking score threshold of the group; generating a third feed comprising one or more posts from the public posts with a corresponding relevance score exceeding the relevance ranking score threshold of the group; generating a graphical user interface comprising the first feed, the second feed, and the third feed; and presenting, at a client device, the graphical user interface.

Example 11 is a computing apparatus comprising: a Processor; and a memory storing instructions that, when executed by the Processor, configure the apparatus to: access group content submissions to an online community platform; compute, using a suggestion retrieval system, a group-to-post relevance score for each post from the group content submissions; identify, using a first machine learning model of the suggestion retrieval system, a set of recommended posts from each post from the group content submissions having the group-to-post relevance score that at least reaches a group-to-post relevance score threshold for a group, wherein the group is associated with a group attribute; classify, using an intent-based ranking system and the group attribute, at least one post from the set of recommended posts as relevant or non-relevant to the group using a second machine learning model of the intent-based ranking system; compute, using the intent-based ranking system, a relevance ranking score of the at least one post from the set of recommended posts classified as relevant to the group using the second machine learning model; and identify, using the intent-based ranking system, a set of suggested posts having the relevance ranking score that at least reaches a relevance ranking score threshold of the group; and cause at least one post of the set of suggested posts to be presented on a device.

In Example 12, the subject matter of Example 11 includes, wherein the instructions further configure the apparatus to: train, using the suggestion retrieval system, the first machine learning model based on semantic attribute data from a first analysis of public posts and group description attributes, and statistical attribute data from a second analysis of group member profile attributes of the online community platform, wherein the group attribute comprises the group description attributes and group member profile attributes, wherein the group content submissions comprise: public posts and pend posts.

In Example 13, the subject matter of Example 12 includes, wherein the first analysis comprises: generate a mapping of groups-to-topic clusters using a group-to-topic clusters machine learning model; generate a mapping of post-to-topic clusters using a filtered posts topic cluster machine learning model, wherein the first machine learn model comprises the group-to-topic clusters machine learning model and the filtered posts topic cluster machine learning model.

In Example 14, the subject matter of Example 13 includes, wherein the instructions further configure the apparatus to: generate a mapping of groups-to-posts based on the mapping of groups-to-topic clusters and the mapping of the post-to-topic clusters.

In Example 15, the subject matter of Example 14 includes, wherein the instructions further configure the apparatus to: compute, using the mapping of groups to posts, the group-to-post relevance score for each post from the public posts and pending posts based on a product of a relevance score of a post-to-topic cluster and a concentration of group posts relevant to a topic cluster.

In Example 16, the subject matter of Examples 14-15 includes, wherein the second analysis comprises: identify the group member profile attributes of the online community platform, wherein the group member profile attributes comprise a skill attribute, an industry attribute, a number of group members attribute, and a number of group members attribute having a predefined skill; compute a statistical analysis relevance score of a skill or an industry for the group based on the group member profile attributes; identify a skill or an industry with the statistical analysis relevance score of the skill or industry for the group exceeding a skill or industry group to post relevance score threshold for the group; generate skill and industry group mapping based identifying the skill or the industry with the statistical analysis relevance score of the skill or industry for the group exceeding the skill or industry group to post relevance score threshold for the group, wherein the group-to-post relevance score is further based on the skill and industry group mapping.

In Example 17, the subject matter of Example 16 includes, wherein the second analysis comprises: identify hashtags from the public posts; and identify relevant hashtags from the hashtags based on hashtag to skills mapping data generated based on a statistical correlation between skills and hashtags.

In Example 18, the subject matter of Examples 13-17 includes, wherein generating the mapping of groups to topic clusters comprises: augment or sanitize the mapping of groups-to-topic clusters by using a natural language inference model (NLI) with a group title and description, and textual representation of interest clusters as inputs, wherein the natural language inference model outputs a probability of two text samples being related to one another.

In Example 19, the subject matter of Examples 11-18 includes, wherein the second machine learn model of the intent-based ranking system comprises: a supervised learning model comprising a Siamese network that assesses a similarity between text of group posts and a group definition; an unsupervised learning model that applies a clustering algorithm to organize group posts into distinct clusters, wherein the intent-based ranking system is configured to combine a first similarity score from the supervised learning model and a second similarity score from the unsupervised learning model to identify a similarity score of published public group content submission or pending group content submission, the similarity score exceeding a predefined threshold indicating a submission as relevant to the group.

Example 20 is a non-transitory computer-readable storage medium, the computer-readable storage medium including instructions that when executed by a computer, cause the computer to: access group content submissions to an online community platform; compute, using a suggestion retrieval system, a group-to-post relevance score for each post from the group content submissions; identify, using a first machine learning model of the suggestion retrieval system, a set of recommended posts from each post from the group content submissions having the group-to-post relevance score that at least reaches a group-to-post relevance score threshold for a group, wherein the group is associated with a group attribute; classify, using an intent-based ranking system and the group attribute, at least one post from the set of recommended posts as relevant or non-relevant to the group using a second machine learning model of the intent-based ranking system; compute, using the intent-based ranking system, a relevance ranking score of the at least one post from the set of recommended posts classified as relevant to the group using the second machine learning model; and identify, using the intent-based ranking system, a set of suggested posts having the relevance ranking score that at least reaches a relevance ranking score threshold of the group; and cause at least one post of the set of suggested posts to be presented on a device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A computer-implemented method comprising:
accessing group content submissions to an online community platform;
computing, using a suggestion retrieval system, a group-to-post relevance score for each post from the group content submissions;
identifying, using a first machine learning model of the suggestion retrieval system, a set of recommended posts from the group content submissions having the group-to-post relevance score that at least reaches a group-to-post relevance score threshold for a group, wherein the group is associated with a group attribute;
classifying, using an intent-based ranking system and the group attribute, at least one post from the set of recommended posts as relevant or non-relevant to the group using a second machine learning model of the intent-based ranking system;
computing, using the intent-based ranking system, a relevance ranking score of the at least one post from the set of recommended posts classified as relevant to the group using the second machine learning model; and
identifying, using the intent-based ranking system, a set of suggested posts having the relevance ranking score that at least reaches a relevance ranking score threshold of the group; and
causing at least one post of the set of suggested posts to be presented on a device.

2. The computer-implemented method of claim 1, further comprising:
training, using the suggestion retrieval system, the first machine learning model based on semantic attribute data from a first analysis of public posts and group description attributes, and statistical attribute data from a second analysis of group member profile attributes of the online community platform,
wherein the group attribute comprises the group description attributes and group member profile attributes,
wherein the group content submissions comprise: public posts and pending posts.

3. The computer-implemented method of claim 2, wherein the first analysis comprises:
generating a mapping of groups-to-topic clusters using a group-to-topic clusters machine learning model;
generating a mapping of post-to-topic clusters using a filtered posts topic cluster machine learning model,
wherein the first machine learning model comprises the group-to-topic clusters machine learning model and the filtered posts topic cluster machine learning model.

4. The computer-implemented method of claim 3, further comprising:
generating a mapping of groups-to-posts based on the mapping of groups-to-topic clusters and the mapping of the post-to-topic clusters.

5. The computer-implemented method of claim 4, further comprising:
computing, using the mapping of groups-to-posts, the group-to-post relevance score for each post from the public posts and pending posts based on a product of a relevance score of a post-to-topic cluster and a concentration of group posts relevant to a topic cluster.

6. The computer-implemented method of claim 4, wherein the second analysis comprises:
identifying the group member profile attributes of the online community platform, wherein the group member profile attributes comprise a skill attribute, an industry attribute, a number of group members attribute, and a number of group members attribute having a predefined skill;
computing a statistical analysis relevance score of a skill or an industry for the group based on the group member profile attributes;
identifying a skill or an industry with the statistical analysis relevance score of the skill or industry for the group exceeding a skill or industry group to post relevance score threshold for the group;
generating skill and industry group mapping based identifying the skill or the industry with the statistical analysis relevance score of the skill or industry for the group exceeding the skill or industry group to post relevance score threshold for the group,
wherein the group-to-post relevance score is further based on the skill and industry group mapping.

7. The computer-implemented method of claim 6, wherein the second analysis comprises:
identifying hashtags from the public posts; and
identifying relevant hashtags from the hashtags based on hashtag to skills mapping data generated based on a statistical correlation between skills and hashtags.

8. The computer-implemented method of claim 3, wherein generating the mapping of groups to topic clusters comprises:
augmenting or sanitizing the mapping of groups-to-topic clusters by using a natural language inference model (NLI) with a group title and description, and textual representation of interest clusters as inputs,
wherein the natural language inference model outputs a probability of two text samples being related to one another.

9. The computer-implemented method of claim 1, wherein the second machine learning model of the intent-based ranking system comprises:
a supervised learning model comprising a Siamese network that assesses a similarity between text of group posts and a group definition;
an unsupervised learning model that applies a clustering algorithm to organize group posts into distinct clusters,
wherein the intent-based ranking system is configured to combine a first similarity score from the supervised learning model and a second similarity score from the unsupervised learning model to identify a similarity score of published public group content submission or pending group content submission, the similarity score exceeding a predefined threshold indicating a submission as relevant to the group.

10. The computer-implemented method of claim 2, further comprising:
generating a first feed comprising one or more posts from the pending posts with a corresponding relevance score exceeding the relevance ranking score threshold of the group;
generating a second feed comprising one or more posts from the pending posts with a corresponding relevance score lower than the relevance ranking score threshold of the group;
generating a third feed comprising one or more posts from the public posts with a corresponding relevance score exceeding the relevance ranking score threshold of the group;
generating a graphical user interface comprising the first feed, the second feed, and the third feed; and
presenting, at a client device, the graphical user interface.

11. A computing apparatus comprising:
a processor; and
a memory storing instructions that, when executed by the processor, configure the computing apparatus to:
access group content submissions to an online community platform;
compute, using a suggestion retrieval system, a group-to-post relevance score for each post from the group content submissions;
identify, using a first machine learning model of the suggestion retrieval system, a set of recommended posts from the group content submissions having the group-to-post relevance score that at least reaches a group-to-post relevance score threshold for a group, wherein the group is associated with a group attribute;
classify, using an intent-based ranking system and the group attribute, at least one post from the set of recommended posts as relevant or non-relevant to the group using a second machine learning model of the intent-based ranking system;
compute, using the intent-based ranking system, a relevance ranking score of the at least one post from the set of recommended posts classified as relevant to the group using the second machine learning model; and
identify, using the intent-based ranking system, a set of suggested posts having the relevance ranking score that at least reaches a relevance ranking score threshold of the group; and
cause at least one post of the set of suggested posts to be presented on a device.

12. The computing apparatus of claim 11, wherein the instructions further configure the computing apparatus to:
train, using the suggestion retrieval system, the first machine learning model based on semantic attribute data from a first analysis of public posts and group description attributes, and statistical attribute data from a second analysis of group member profile attributes of the online community platform,
wherein the group attribute comprises the group description attributes and group member profile attributes,
wherein the group content submissions comprise: public posts and pend posts.

13. The computing apparatus of claim 12, wherein the first analysis comprises:
generate a mapping of groups-to-topic clusters using a group-to-topic clusters machine learning model; and
generate a mapping of post-to-topic clusters using a filtered posts topic cluster machine learning model,
wherein the first machine learning model comprises the group-to-topic clusters machine learning model and the filtered posts topic cluster machine learning model.

14. The computing apparatus of claim 13, wherein the instructions further configure the computing apparatus to:
generate a mapping of groups-to-posts based on the mapping of groups-to-topic clusters and the mapping of the post-to-topic clusters.

15. The computing apparatus of claim 14, wherein the instructions further configure the computing apparatus to:
compute, using the mapping of groups-to-posts, the group-to-post relevance score for each post from the public posts and pending posts based on a product of a relevance score of a post-to-topic cluster and a concentration of group posts relevant to a topic cluster.

16. The computing apparatus of claim 14, wherein the second analysis comprises:
identify the group member profile attributes of the online community platform, wherein the group member profile attributes comprise a skill attribute, an industry attribute, a number of group members attribute, and a number of group members attribute having a predefined skill;
compute a statistical analysis relevance score of a skill or an industry for the group based on the group member profile attributes;
identify a skill or an industry with the statistical analysis relevance score of the skill or industry for the group exceeding a skill or industry group to post relevance score threshold for the group;
generate skill and industry group mapping based identifying the skill or the industry with the statistical analysis relevance score of the skill or industry for the group exceeding the skill or industry group to post relevance score threshold for the group,
wherein the group-to-post relevance score is further based on the skill and industry group mapping.

17. The computing apparatus of claim 16, wherein the second analysis comprises:
identify hashtags from the public posts; and
identify relevant hashtags from the hashtags based on hashtag to skills mapping data generated based on a statistical correlation between skills and hashtags.

18. The computing apparatus of claim 13, wherein generating the mapping of groups to topic clusters comprises:
augment or sanitize the mapping of groups-to-topic clusters by using a natural language inference model (NLI) with a group title and description, and textual representation of interest clusters as inputs,
wherein the natural language inference model outputs a probability of two text samples being related to one another.

19. The computing apparatus of claim 11, wherein the second machine learning model of the intent-based ranking system comprises:
a supervised learning model comprising a Siamese network that assesses a similarity between text of group posts and a group definition;
an unsupervised learning model that applies a clustering algorithm to organize group posts into distinct clusters,
wherein the intent-based ranking system is configured to combine a first similarity score from the supervised learning model and a second similarity score from the unsupervised learning model to identify a similarity score of published public group content submission or pending group content submission, the similarity score exceeding a predefined threshold indicating a submission as relevant to the group.

20. A non-transitory computer-readable storage medium, the computer-readable storage medium including instructions that when executed by a processor, cause the processor to:
access group content submissions to an online community platform;
compute, using a suggestion retrieval system, a group-to-post relevance score for each post from the group content submissions;
identify, using a first machine learning model of the suggestion retrieval system, a set of recommended posts from the group content submissions having the group-to-post relevance score that at least reaches a group-to-post relevance score threshold for a group, wherein the group is associated with a group attribute;
classify, using an intent-based ranking system and the group attribute, at least one post from the set of recommended posts as relevant or non-relevant to the group using a second machine learning model of the intent-based ranking system;
compute, using the intent-based ranking system, a relevance ranking score of the at least one post from the set of recommended posts classified as relevant to the group using the second machine learning model; and
identify, using the intent-based ranking system, a set of suggested posts having the relevance ranking score that at least reaches a relevance ranking score threshold of the group;
and cause at least one post of the set of suggested posts to be presented on a device.
